(19) United States
(12) Patent Application Publication
(10) Pub. No.: US 2013/0043197 A1
(43) Pub. Date: Feb. 21, 2013

(54) Tangential Flow Particle Separator and Method Therefor

(71) Applicant: Richard Karl Krouzecky, Iluka (AU)

(72) Inventor: Richard Karl Krouzecky, Iluka (AU)

(21) Appl. No.: 13/576,134

(22) PCT Filed: Jan. 31, 2011
(86) PCT No.: PCT/AU2011/000090

§ 371 Date: Oct. 22, 2012

(30) Foreign Application Priority Data
Jan. 30, 2010 (AU) 2010900364

(51) Int. Cl. B01D 21/00

(52) U.S. Cl. 210/800; 210/513

(57) ABSTRACT

A particle separating apparatus for fluids containing particulate material, treatment system for treating effluent from a processing plant, and a method of separating particles from fluid. A treatment vessel has an inlet for injecting fluid containing particulate material, and a plurality of outlets for separately discharging separated supernatant on the one hand, and separated particles on the other hand, from the fluid. An outer annular treatment region receives fluid injected tangentially into said treatment vessel from the inlet and directs the fluid into a transverse, laminar flow within the vessel about a central axis. An inner particle separating region communicates with the outer treatment region but is separated therefrom by a baffle to permit ingress of the injected fluid gradually from the transverse flow in a radially converging manner that maintains the laminar flow for fluid. The fluid eventually reposes centrally of the treatment vessel for optimum residency in the inner particle separating region. The baffle mitigates the effects of the angular fluid motion in the outer annular treatment region on fluid within the inner separating region. A lower particle collection region communicates with both the lower portion of the outer treatment region and said inner particle separating region for receiving separated particles from the fluid having a higher specific gravity. An upper supernatant separating region communicates with the top of the inner particle separating region for egressing supernatant from the fluid for extraction. The baffle has a recess opening from the depending thereof behind the inlet and spanning a sector of approximately 90°.

The present application is a U.S. National Phase application of and claims priority from PCT/AU2011/000090, filed on Jan. 31, 2011 designating the United States, which in turn was based on and claimed priority from Australian Patent Application No. 2010900364 filed Jan. 30, 2010 all of which applications are incorporated herein by reference.

### FIELD OF THE INVENTION

This invention relates to particle separation and treatment vessels, methods and systems therefor.

Such vessels are more specifically known in the industry as clarifiers, and have particular, but not exclusive, application to waste water treatment. The present invention is more particularly concerned with the separation of particles from fluids involving the tangential flow of the fluid within the treatment vessel.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

There have been a number of problems associated with particle separation in the art of waste water treatment in the past, which have tended to have eluded ready solution.

One such problem was what is known in the art as “sludging-up” of the treatment vessel or clarifier. Sludging up arises over time in clarifiers using chemical coagulation and flocculation techniques to promote the separation of particles, where dense particles tend to fill up or line the clarifier around the lower walls of the clarifier vessel, adjacent to the lower outlets. As this sludge builds up, a problem known as the “rat-hole” effect occurs. The rat-hole effect occurs where accumulating less dense particles move upward towards the lower pressure areas of the vessel. The egress of these accumulating denser particles into these lower pressure areas, reduces the efficacy of the vessel to the point that it becomes unusable.

Another problem with prior art treatment vessels is their size. Such vessels have been relatively large in volume and thus have been constructed in situ. This presents a two-fold problem. Firstly, it is relatively expensive to transport, install and disassemble components when commissioning and decommissioning a treatment system utilising such vessels. Secondly, the large size of the vessel means that flow rates are relatively slow, exacerbating the problem of “sludging”.

A further problem associated with prior art treatment vessels is their inefficient design characteristics. In tangential flow separation, the relative size of the area for flocculation should be maximised and laminar flow needs to be optimised. Many prior art designs include a top compartment having a radial wall that divides the top compartment from the main flocculation area and which has a baffle extending a significant distance axially into the treatment vessel in order to create an outer annular region and an inner columnar region to promote laminar flow. The reduction in the size of the flocculation area reduces the efficiency of the particle separation process to what may otherwise be achieved if the flocculation area were larger, but has the advantage of separating the outer annular region of the vessel where there is greater angular flow of the fluid from the inner columnar region which promotes residency time of the fluid in the flocculation area.

Such designs however, lead to problems as where to introduce the fluid into the vessel. Ideally the fluid needs to be inlet within the annular region to promote annular flow. However, with a depending baffle that terminates well below the fluid inlet, the purpose of the clarifier which relies upon the principle of less dense clarified fluid rising, and more dense separated particles falling, tends to be defeated. Moreover, as the fluid clarifies from the coagulation and flocculation processes occurring within the outer annular region, it has to move downward to clear the depending edge of the baffle before it may be able to enter the main flocculation area for subsequent extraction as supernatant. Alternatively, if the fluid is inlet below the baffle to allow clarified fluid to enter the columnar region more easily, the baffle cannot be used as effectively to produce laminar flow, and less dense fluid tends to become trapped in the upper confines of the annular region without being able enter the main flocculation treatment area of the vessel.

In either case, these designs tend to be inefficient and lack efficacy for treatment of large volumes of waste water.

### DISCLOSURE OF THE INVENTION

This invention seeks to address and alleviate some or all of the aforementioned problems associated with the prior art by providing for a new type of particle separating apparatus and process for operating same within a fluid treatment system.

In a first aspect of the present invention, there is provided a particle separating apparatus for fluids containing particulate material, comprising:

a treatment vessel having an inlet for injecting fluid containing particulate material, and a plurality of outlets for separately discharging separated supernatant on the one hand, and separated particles on the other hand, from the fluid;

an outer annular treatment region for receiving fluid injected tangentially into said treatment vessel from said inlet and directing said fluid into a transverse, laminar flow within the vessel about a central axis thereof;

an inner particle separating region communicating with the outer treatment region to permit ingress of the injected fluid gradually from the transverse flow in a radially converging manner that maintains the laminar flow for fluid to eventually repose centrally of the treatment vessel for optimum residency in the inner particle separating region whilst mitigating the effects on fluid therein from the angular motion of fluid in the outer annular treatment region;

a lower particle collection region communicating with both the lower portion of the outer treatment region and said inner particle separating region for receiving separated particles from the fluid having a higher specific gravity; and

an upper supernatant separating region communicating with the top of the inner particle separating region for egressing supernatant from the fluid for extraction.

Preferably, the particle separating apparatus includes a cylindrical baffle that positively separates the outer annular treatment region from the inner particle separating region and the upper supernatant separating region; the baffle having an axially extending recessed portion: (i) opening from the depending end of the baffle; (ii) defining an apex proximate to the axial position of the inlet; and (iii) spanning a transverse portion of the baffle immediately rearward of the inlet.

Preferably, the recess spans a sector of the baffle of approximately 90°.

Preferably, the recess is parabolic in shape.

Preferably, the transversely extending arc of the baffle from an axial extent proximately aligned with the point of inflection of the recessed portion at the depending end of the baffle that is distal relative to the rear of the inlet, is of progressively lessening radius until the apex, so as to maintain and direct the laminar flow of fluid from the outer annular treatment region into the inner particle separating region, axially along the baffle.

Preferably, the particle separating apparatus includes a supernatant discharge chamber for receiving egressed supernatant from the upper supernatant separating region and allowing discharge of the supernatant therefrom.

Preferably, the outer annular treatment region is closed at the top thereof to collect buoyant particles.

Preferably, the upper supernatant separating region includes a weir to allow received supernatant to egress through for collection and retain buoyant particles having a lower specific gravity from the fluid for eventual extraction.

In one embodiment, the upper supernatant separating region may include a settling chamber to receive supernatant from the top of the inner particle separating region prior to egressing the supernatant for extraction.

In this embodiment, preferably the upper supernatant separating region includes a flow inverter to create a tortuous path for flow of supernatant from the top of the inner particle separating region into the settling chamber.

In another aspect of the present invention, there is provided a treatment system for treating effluent from a processing plant, including: a reagent dosing station to dose the effluent with reagents in a controlled manner; a particle separating station comprising one or more apparatus as defined in the preceding aspect of the invention; a particles discharge station to return separated particles from the separating apparatus to the processing plant for treatment or extraction; a sludge discharge station to return sludge extracted from the separating apparatus to the processing plant for treatment or extraction; and a supernatant collection station to collect supernatant from the separating apparatus for subsequent use.

In a further aspect of the present invention, there is provided a method of separating particles from fluid comprising: introducing fluid tangentially into a laminar flow at a fixed location; gradually directing said fluid radially inwardly from a region behind the fixed location in a vortex maintaining the laminar flow until the fluid reaches the centre for optimum residency where transverse flow is reduced and axial flow subject to gravity is enhanced; separating an outer annular treatment region of the fluid having angular fluid motion proximate to the fixed location from an inner particle separating region having fluid with a lesser angular fluid motion to shield fluid within the inner particle separating region from the effects of angular fluid motion in the outer annular treatment region; accumulating fluid with low specific gravity towards the top and collecting particles and fluid with high specific gravity towards the bottom; and egressing fluid radially outward from the top to extract supernatant therefrom.

Preferably, the method includes slowly agitating the collected particles and fluid at the bottom to mitigate rising thereof.

Preferably, egressing the extracted supernatant from the top includes separating buoyant particles having a lower specific gravity from the supernatant.

In one embodiment, the method may include passing the fluid through a flow inverter to settle before egressing the fluid to extract supernatant therefrom.

### BRIEF DESCRIPTION OF THE DRAWINGS

The drawings accompanying the following description of the best mode(s) for carrying out the invention are as follows:

FIG. 1 is a fragmentary side elevation of the preferred embodiment of a treatment vessel of a particle separating apparatus according to the best mode for carrying out the invention, showing a tank on a stand;

FIG. 2 is top view of the tank in FIG. 1;

FIG. 3 is a similar view to FIG. 1, but with a cut-away section of the external tank wall to show some of the inner components of the tank;

FIG. 4 is a part cross-sectional view of FIG. 1 to show the majority of the inner components of the tank;

FIG. 5 is a top view of the tank taken through section A-A of FIG. 4, showing the arrangement of the legs of the stand;

FIG. 6 comprises three drawings showing various aspects of the V-notch weir and baffle unit wherein:

FIG. 6a is a plan view of the unit;

FIG. 6b is a fragmentary side elevation view of a portion of the top of the V-notch weir; and

FIG. 6c is a top perspective view of the overall unit;

FIG. 7 comprises two drawings showing different views of the inlet pipe forming the inlet to the tank, wherein:

FIG. 7a is an end view of the inlet pipe showing the connecting flange in plan; and

FIG. 7b is a side view showing the inner end of the pipe as it is attached to the inside of the outer vessel wall, and the distal arrangement of the connecting flange;

FIG. 8 is a sectional view of a portion of the tank showing the relative location of a vent and annular gutter;

FIG. 9 comprises two views showing the outlet launder of the supernatant discharge means, wherein:

FIG. 9a is an outer radial view showing the launder positioned on the outside of the tank; and

FIG. 9b is cross-sectional view through section B-B of FIG. 9a;

FIG. 10 is a fragmentary side view of a portion of the tank showing the relative location of the floaters outlet pipe to the outer annular treatment region and the frusto-conical portion of the baffle;

FIG. 11 is a schematic diagram showing key parts of the tank and the direction of fluid flow therein;

FIG. 12 is a plan and information drawing of a fluid treatment system including the particle separating apparatus as described in any of the embodiments;

FIG. 13 is a plan view of the fluid treatment system of FIG. 12 in situ;

FIG. 14 is a part cross-sectional view of a first embodiment of a treatment vessel of a particle separating apparatus according to another mode for carrying out the invention, showing the majority of the inner components of the tank, with the scraper and motor drive of the apparatus removed;

FIG. 15 is a plan view of FIG. 14 with the lid removed;

FIG. 16 is a cross-sectional side elevation of a second embodiment of the treatment vessel according to the other mode for carrying out the invention, with the scraper and motor drive of the apparatus removed;

FIG. 17 is a plan view of FIG. 16;

FIG. 18 comprises two drawings showing different views of the lid that closes the upper supernatant treatment region of the vessel of FIG. 16, wherein:

FIG. 18a is a cross-sectional side elevation of the lid; and

FIG. 18b is top view of the lid;

FIG. 19 is a cross-sectional side elevation of one embodiment of the treatment vessel according to a further mode for carrying out the invention;

FIG. 20 is a cross-sectional side elevation of another embodiment of the treatment vessel according to the further mode for carrying out the invention.

### BEST MODE(S) FOR CARRYING OUT THE INVENTION

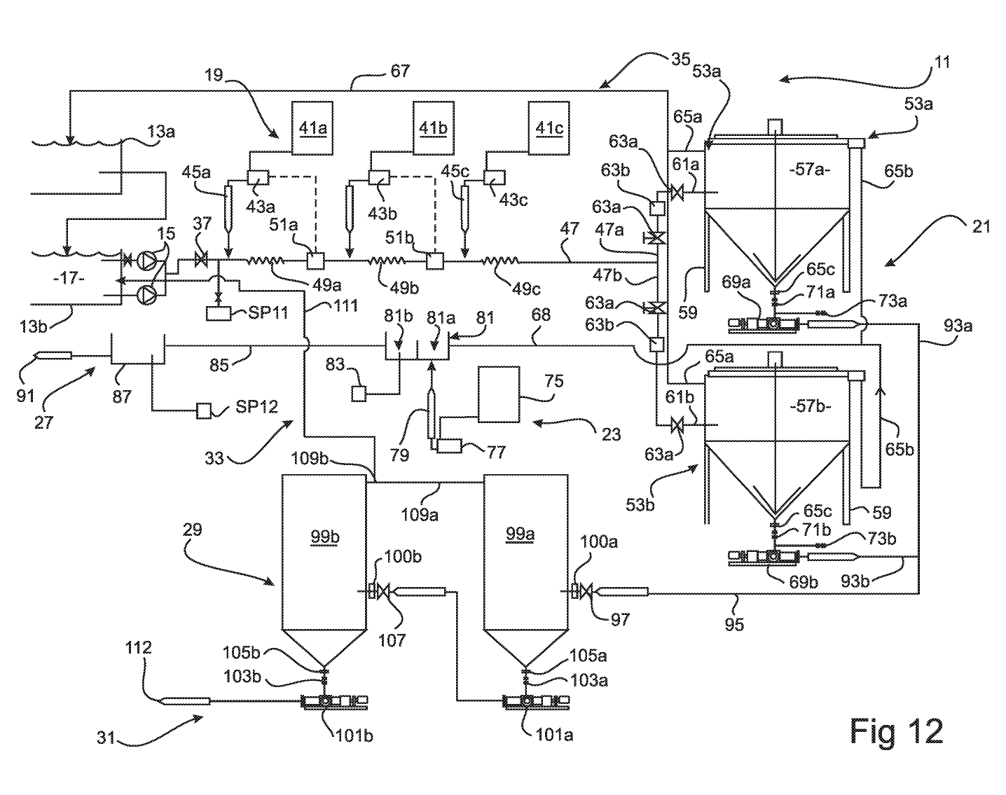

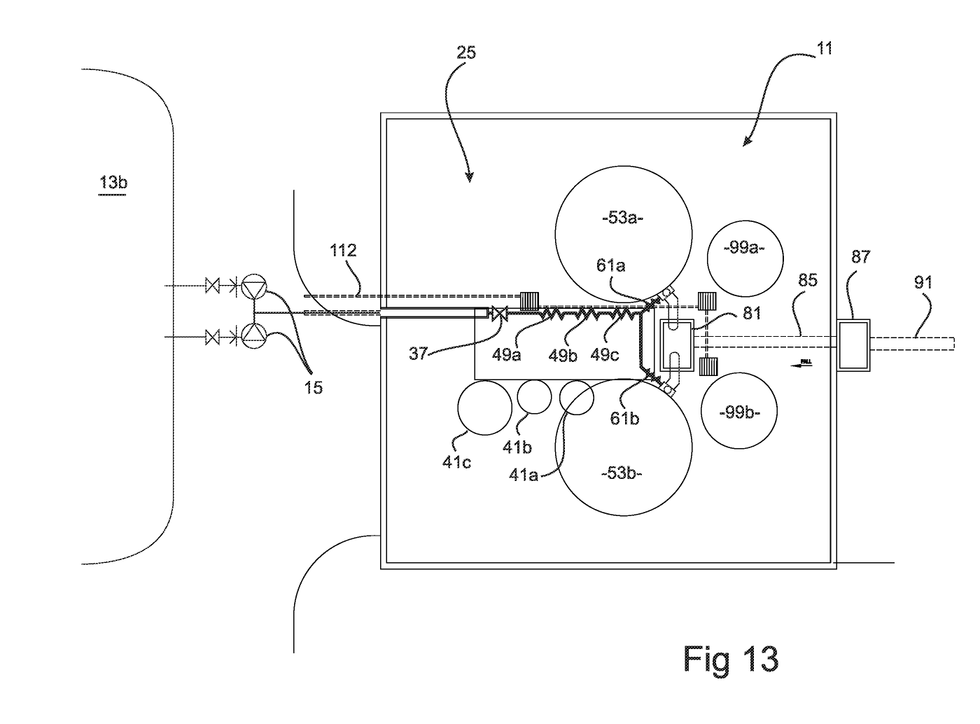

The best mode for carrying out the invention is in a fluid treatment system of the kind shown in FIGS. 12 and 13.

The fluid treatment system 11 is particularly designed for the treatment of effluent from a processing plant (not shown) posited into a series of settling ponds 13a to 13b that provide an initial treatment of the effluent and separation of particles therefrom. Hence, in the context of the present description, the fluid treatment system constitutes a subsequent treatment of the effluent, after it has progressed through an initial treatment via the series of settling ponds 13. Thus the final settling pond 13b forms a reservoir of particulate fluid from which one or more infeed pumps 15 pump effluent 17 in the form of particulate fluid from the pond to the fluid treatment system 11.

The fluid treatment system 11 essentially comprises a plurality of stations each constituting a different stage in the subsequent treatment process of the effluent. These stages generally comprise: a reagent dosing stage provided at a reagent dosing station 19; a particle separating stage provided at a particle separating station 21; a primary supernatant treatment stage provided at a primary supernatant treatment station 23; a supernatant sampling stage provided at a supernatant sampling station 27; a sludge thickening stage provided at a thickening station 29; a sludge discharge stage provided at a sludge discharge station 31; a secondary supernatant return stage provided at a secondary return station 33; and a particle return stage provided at a particle return station 35.

The effluent 17 in the settling pond 13b is isolated from the fluid treatment system 11 by a main isolation valve 37.

The reagent dosing station 19 comprises a series of storage tanks 41a, 41b, 41c, each associated with a dosing pump 43a, 43b, 43c to inject different reagents 45a, 45b, 45c into the main inflow stream 47 from the final settling pond 13b at successive locations as shown in FIG. 12.

The reagent comprises coagulant, flocculent and pH adjuster, each of which are introduced and suitably mixed into the fluid stream by in-line static mixers 49a, 49b, 49c, which in the present embodiment are of a simple baffle type design. pH meters 51a and 51b are included in the inflow stream after the injection of the first and second reagents, and depending upon requirements, other pH meters may be included at various stages of the system to provide feedback to injection of the pH adjuster in order to keep the system operating within prescribed limits.

The main inflow fluid stream 47, after passing through the reagent dosing station, is then input into the particle separating station 21. The particle separating station 21 comprises a series of particle separating clarifiers 53a, 53b that are designed to operate in parallel with each other. These clarifiers 53 are each designed to operate with a Biological Oxygen Demand (BOD)≦20 and comprise a treatment vessel 55 including a tank 57 and stand 59. The design of the treatment vessel 55 is essentially the same each instance, but is individually tuned in order to allow optimum residency times for the fluid.

The design and operation of the particle separating clarifiers 53 will be described in more particular detail later.

At the system level, the main inflow fluid stream 47 is split into parallel streams 47a, 47b that are respectively connected to the input line 61a, 61b of each separating clarifier via isolation valves 63a and flowmeters 63b. Each separating apparatus has a plurality of outlet lines 65 for directing flow of the different types of separated fluid and particles from the tank 57 thereof. These outlet lines comprise: a particles discharge line 65a; a supernatant return line 65b; and a sludge return line 65c.

The particles discharge line 65a is provided for directing separated buoyant floaters and particles from the tank 57 to a main return line 67 that periodically is opened to return the separated and particles to the head of the initial treatment stage, which in this embodiment is the first settling pond 13a.

The supernatant return line 65b is provided for directing separated supernatant from the tank 57 into a main supernatant outflow stream 68, and to the supernatant treatment station 23.

The respective sludge return lines 65c are located at the bottom of each tank 57a, 57b and direct residual sludge from the tanks to a sludge pump 69a, 69b associated with each treatment vessel 55a, 55b via a corresponding pump isolation valve 71a, 71b. Each pump isolation valve 71 has a corresponding bypass valve 73a, 73b associated therewith.

The sludge pumps 69 are selectively operated to pump sludge from the respective tanks 57 to the thickening station 29.

The supernatant treatment station 23 comprises a partitioned collecting sump 81 and another pH adjuster having a storage tank 75, dosing pump 77 and a reagent injection line 79. The reagent injection line 79 selectively introduces reagent into the first compartment 81a of the sump where the supernatant outflow stream 68 is inlet. This first compartment 81a has sufficient turbulence from the supernatant outflow stream 68 to properly mix the reagent with the supernatant in order to provide for pH correction as necessary.

The supernatant with corrected pH then flows to the second compartment 81b of the collecting sump 81 where it settles to facilitate measurement of the pH using a pH probe 83.

Supernatant the flows from the collecting sump via line 85 to be directed to the supernatant sampling station 27, where it is received within a supernatant sampling sump 87. The supernatant can be sampled at the sampling sump for BOD or other measurements to allow for further tuning before discharge at 91.

In the present embodiment, clarified supernatant having a BOD of 20, in most instances, would be directed back for re-use in the processing plant.

Sludge pump outlet lines 93a, 93b connect into a primary sludge line 95 that inputs primary sludge via an isolation valve 97 to the thickening station 29.

The thickening station 29 comprises a series of sludge thickening tanks 99a, 99b, each having its own inlet 100a, 100b to input sludge into the tank, and its own sludge pump 101a, 101b and isolation valve 103a, 103b for pumping sludge from a sludge outlet 105a, 105b provided at the base of each thickening tank 99.

In the case of the first sludge thickening tank 99a, the inlet 100a receives primary sludge from the primary sludge line 95 and pumps secondary sludge via the sludge pump 101a to the inlet 100b of the second sludge thickening tank 99b.

The second sludge thickening tank receives secondary sludge at its inlet 100b via an isolation valve 107.

Each sludge thickening tank 99 has a secondary supernatant return line 109a, 109b, which connects into a main secondary supernatant discharge line 111 forming the secondary supernatant return station 33.

The main secondary supernatant discharge line 111 in turn directs secondary supernatant to the final settling pond 13b for subsequent treatment by the fluid treatment system 11.

The second sludge thickening tank 99b ultimately pumps sludge from its sludge pump 101b to a slump discharge outlet 112.

The fluid treatment system 11 has provision for two sampling points SP:1 and SP:2 for the purposes of testing the BOD at these points. The first sampling point is disposed in the main inflow stream 47, upstream from the reagent dosing station 19, to check that the BOD is less than 200. The second sampling point SP:2 is disposed at the supernatant sampling station 27 to ensure that the BOD 20.

FIG. 13 shows how the fluid treatment system 11 would be laid out physically in-situ. All of the stations of the system are positioned in a compact manner on a foundation apron 25 such as a concrete slab. The various instrumentation and control valves of the system are housed in a plant room 89 for security purposes, and the tanks, pipes and sumps are located externally of the plant room at appropriate locations on the apron 25 as shown.

The operation of the treatment system 11 is known in the art to suitably skilled fluid treatment personnel and will not be described further.

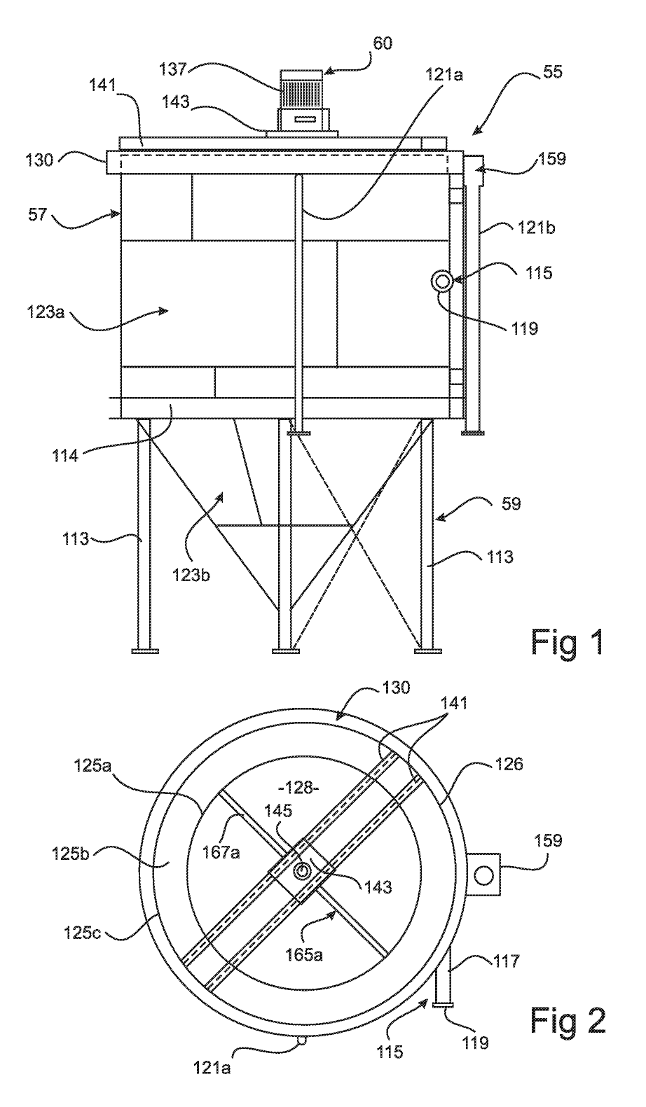

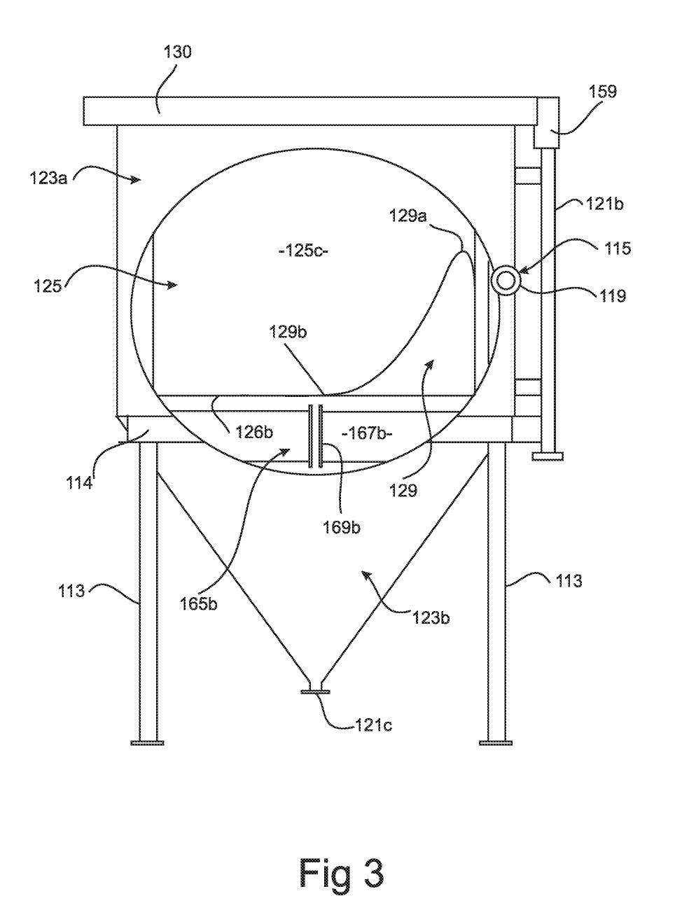

The design of the fluid separating clarifier 53 according to the best mode of carrying out the invention will now be described with reference to FIGS. 1 to 11 of the drawings.

The fluid separating apparatus 53 that is used in the best mode of carrying out the invention has one preferred embodiment.

Other modes for carrying out the invention are subsequently described with respect to several specific embodiments.

In the first embodiment, as shown in FIG. 1, the treatment vessel 55 comprises a tank 57 having an upper cylindrical wall portion 123a and a lower conical wall portion 123b at an incline of approximately 60°, both portions defining a central axis of the tank. The incline of the conical wall portion 123b needs to be about 60° or more to ensure fall of the sludge on the inside walls of the tank in order to mitigate the rat hole effect as described previously. The treatment vessel 55 also comprises a stand 59 and, a scraper unit 60 which is mounted to the top of the tank.

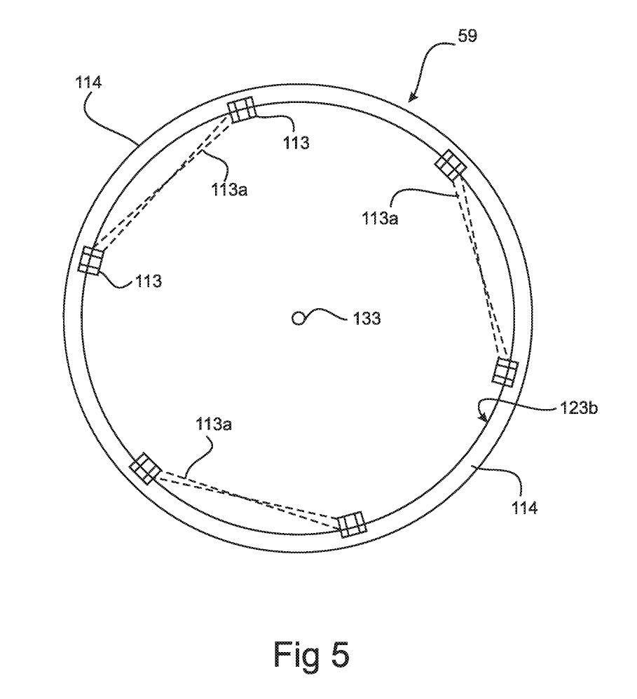

The stand 59, as better shown in FIG. 5, comprises six legs 113 welded to an annular base 114 made from RJS steel. The annular base 114 forms a nest within which the concial portion 123b is seated and to which the upper cylindrical portion 123a is secured. The legs 113 are stabilised by cross-bracing 113a in accordance with standard structural design.

The tank 57 comprises a main inlet connector 115 having an inwardly extending pipe portion 117, and a connecting flange 119. The tank also comprises a plurality of outlets 121. These outlets 121 include: a floaters outlet 121a, a supernatant 121b, and a sludge 121c; each of which respectively connect to the particles discharge line 65a, the supernatant return line 65b, and the sludge return line 65c. An inner particles connector 121d and an outer particles connector 121e also connect to the particles discharge line 65a to extract settled particles from different locations within the tank 57.

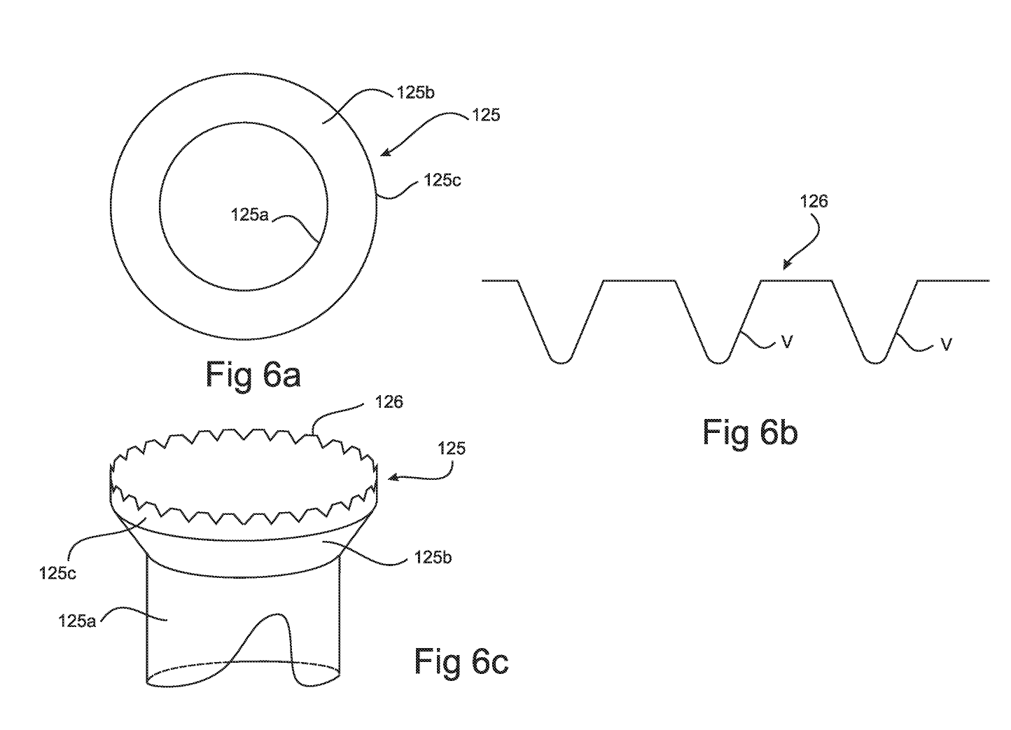

The interior of the cylindrical wall portion 123a of the tank 57 is divided into discrete transverse regions by an inner cylindrical baffle 125, which is concentrically disposed with the cylindrical wall portion 123a. As best shown in FIG. 6, the baffle 125 has: (i) a depending cylindrical skirt portion 125a of smaller radius than the tank; (ii) an intermediate frusto-conical skirt portion 125b that extends from the top of the depending cylindrical skirt portion 125a to the inner wall of the cylindrical wall portion 123a of the tank; and (iii) an upper cylindrical skirt portion 125c that forms the top of the tank.

The arrangement of the baffle 125 within the tank creates an outer annular treatment region 127 and an inner particle separating region 128. The outer annular treatment region is disposed between the depending cylindrical skirt portion 125b and the inner wall of the cylindrical wall portion 123a, and is closed at the top by the intermediate frusto-conical skirt portion 125b. The inner particle separating region 128 is disposed within the baffle forming an inner columnar region within the tank that is shielded from the outer annular treatment region 127 by the depending cylindrical skirt portion 125a and the frusto-conical skirt portion 125b of the baffle, but which allows free axial movement of fluid therein, depending upon the specific gravity thereof.

An annular gutter 130 is formed on the upper periphery of the tank 57, so that the upper cylindrical skirt portion 125c defines an inner weir that allows fluid to spill over from the top of the inner particle separating region 128, into the gutter.

The upper cylindrical skirt portion 125c is formed with an upper edge 126a that is ‘V’ notched to define a ‘V’ notch weir portion that functions to allow the fluid to pass from the inside of the upper cylindrical skirt portion 125c, through the bottom of the ‘V’ and into the annular gutter 130.

The depending skirt portion 125a is formed with an axially extending recessed portion 129: (i) opening from the depending end 126b thereof; (ii) defining an apex 129a proximate to the axial position of the inlet; and (iii) spanning a transverse portion of the baffle 125 immediately rearward of the entry point of the inwardly extending pipe portion 117 to the inside of the tank.

In the present embodiment, the recessed portion 129 spans a sector of the baffle 125 of approximately 90° and is parabolic in shape. The transversely extending arc of the baffle is of progressively lessening radius than the remaining sector of the baffle, from an axial extent proximately aligned with the point of inflection 129b of the recessed portion at the depending end 126b of the baffle 125 that is distal relative to the rear of the entry point of the inwardly extending pipe portion 117 into the tank, until the apex 129a, so as to maintain and direct the laminar flow of fluid from the outer annular treatment region 127 into the inner particle separating region 128, axially along the baffle 125.

The inwardly extending pipe portion 117 is located tangentially to the inner wall of the tank at an intermediate axial location along the depending cylindrical skirt portion 153a, marginally below the apex 129a of the recessed portion, but in advance thereof angularly around the skirt portion, so that the entry point of the inwardly extending pipe portion 117 is at a position where cylindrical skirt portion 125a is of full axial extent. In this manner, the skirt portion 125 biases the tangential flow of the fluid entering the inner annular treatment region 127 into a laminar transverse flow about the central axis and gradually allows egress of fluid to converge radially inward towards the skirt portion and ultimately into the inner particle separating region 128 without disrupting the laminar flow.

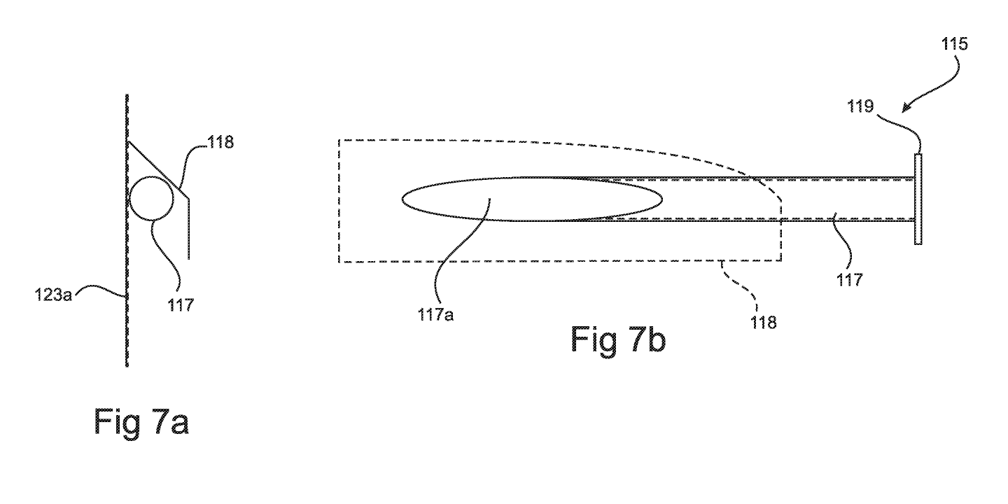

As shown in FIG. 7a, the pipe 117 of the main inlet connector 115 extends inwardly of the cylindrical wall portion 123a of the tank in a tangential direction. The inner end of the pipe 117 is cutaway diagonally to form a tapered inner part 117a on the inside of the tank that facilitates introducing fluid entering the tank in a laminar flow within the outer annular treatment region 127.

As shown in FIG. 7b, the tapered inner part 117a has a shroud 118 covering the top of the pipe 117 to help with entraining inlet fluid into the laminar flow and preventing the tendency of low specific gravity particles to plume upwards immediately on entering the tank. The shroud in 118 is shown in dotted outline in order to reveal the tapered inner part 117a of the pipe 117.

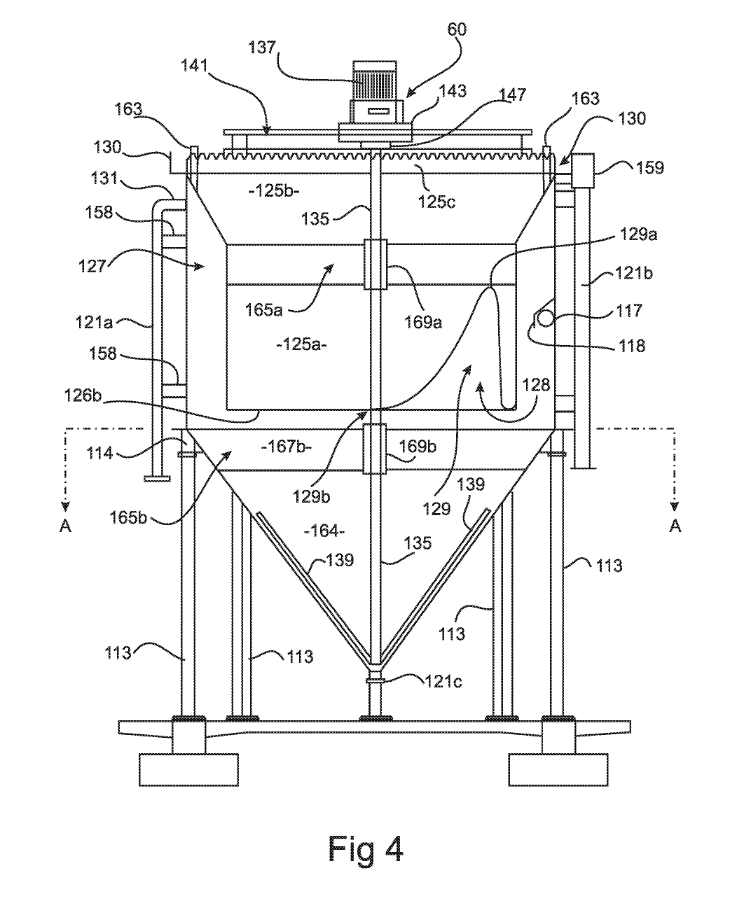

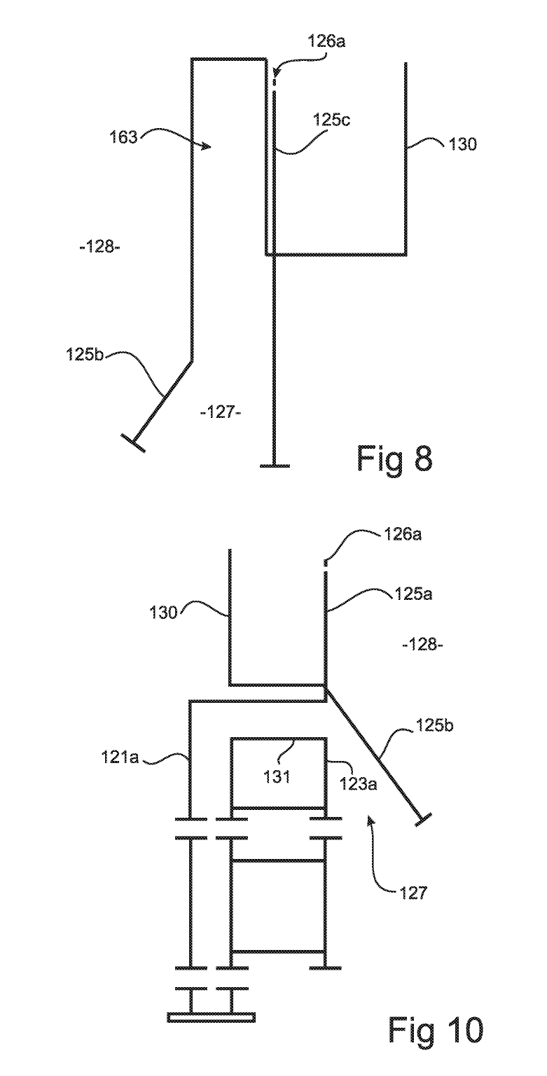

As previously described, the annular gutter 130 forms part of the supernatant discharge means. As shown in FIG. 8 of the drawings, a vent 163 is provided in the uppermost extent of the intermediate frusto-conical skirt portion 125b adjacent to its junction with the upper cylindrical skirt portion 125c. The vent rises sufficiently above the upper edge 126a of the ‘V’ notch weir portion to clear supernatant collected in the annular gutter 130 and vent gases that build up in the outer annular treatment region 127. As shown in FIG. 4 of the drawings a plurality of vents 163 is provided.

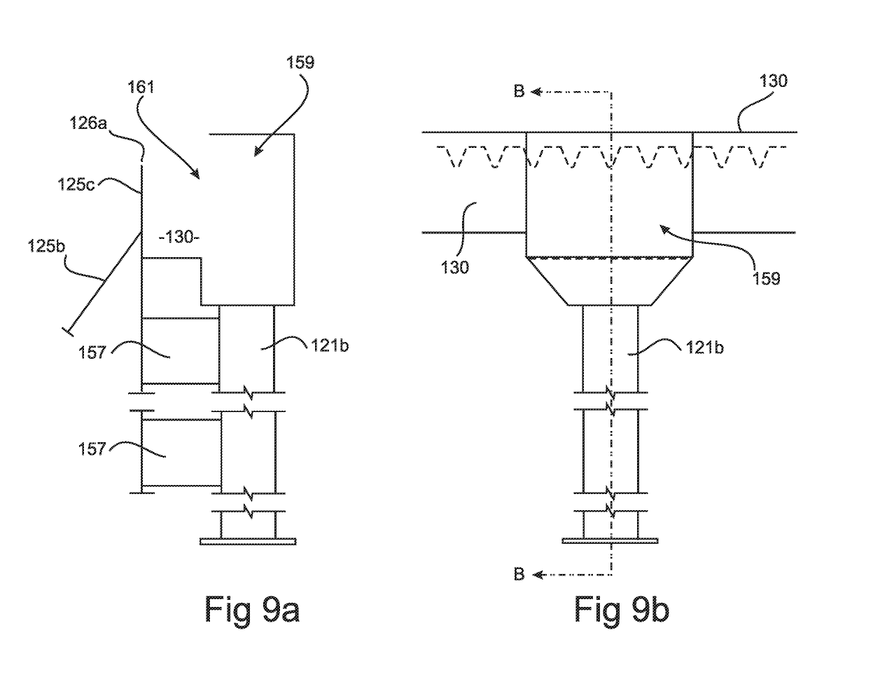

As shown in FIG. 9, the supernatant discharge means also includes a launder 159 that receives supernatant collected within the gutter 130 through a passageway 161. The launder 159 provides a convenient location for the supernatant connector 121b to be disposed thereon in a downward direction. The supernatant connector 121b is fixedly located to the side of the tank by a pair of supporting brackets 157.

As shown in more detail in FIG. 10, the floaters pipe 121a is also affixed to the outside of the tank with a pair of brackets 158 and has an inlet 131 connected to the top of the outer annular treatment region 127, just beneath the junction between the intermediate frusto conical skirt portion 125b and the inner wall of the cylindrical wall portion 123a of the tank. In this manner, floaters of relatively low specific gravity but solid state, and supernatant that may collect within the outer annular treatment region as a result of flocculation and which evades entry into the inner particle separating region, may be drawn off.

The lower conical wall portion 123a of the tank 57 forms a lower particle collection region 164 that communicates with both the lower portion of the outer treatment region 127 and the inner particle separating region 128. In this manner it receives separated particles from the fluid that have a higher specific gravity, which eventually sink under the influence of gravity to the bottom of the tank. These particles tend to congregate and form sludge. Accordingly, the sludge outlet connector 121c is disposed at the bottom of the lower conical wall portion 123a and has an aperture 133 communicating with the lower particle collection region to remove sludge therefrom.

The tank 57 is also provided with a pair of vortex breakers 165, each comprising a series of vanes 167 to restrict transverse flow of fluid at the top of the inner particle separating region 128 and at the top of the lower conical wall portion 123b.

As shown best in FIGS. 4 and 5, the upper vortex breaker 165a has vanes 167a attached to a central bush 169a that extend radially along the top of the inner particle separating region and adjoin the inner wall of the depending cylindrical skirt portion 125a at discrete transverse locations around the circumference thereof. The lower vortex breaker 165b similarly has vanes 167b attached to a central bush 169b that extend radially along the top of the lower conical wall portion 123b, below the inner baffle 125, to adjoin the inner wall of the lower conical wall portion 123b at discrete transverse locations around the circumference thereof.

The bushes 169 are coaxially aligned with the central axis of the tank and accommodate a shaft 135 for the scraper unit 60. The shaft 135 extends from a motor drive 137 mounted to the top of the tank 57 down to a pair of scraper blades 139 disposed within the bottom of the lower conical wall portion 123b of the tank.

The motor drive 137 of the scraper unit 60 is mounted on a subframe comprising a pair of parallel spaced RSJ beams 141 surmounting the top 126a of the V-notch weir portion of the upper cylindrical skirt portion 125c. A rectangular mounting plate 143 for the motor drive is affixed to the top of the beams 141 and is provided with a central aperture 145 to accommodate the shaft 135 and bearing arrangement 147.

The scraper blades 139 are angled to correspond to the inclination of the conical wall portion 123b and are disposed to provide minimal clearance between the bottom edge of each blade and the inner surface of the conical wall portion. The motor drive 137 is operated at a low torque to continuously but slowly rotate the shaft 135 and the scraper blades 139 within the tank during the separation process. In this manner sludge that otherwise would build upon on the wall of the conical wall portion 123b and create the rat-hole effect is agitated and dispersed so that it may be completely discharged via the sludge connector 121c periodically.

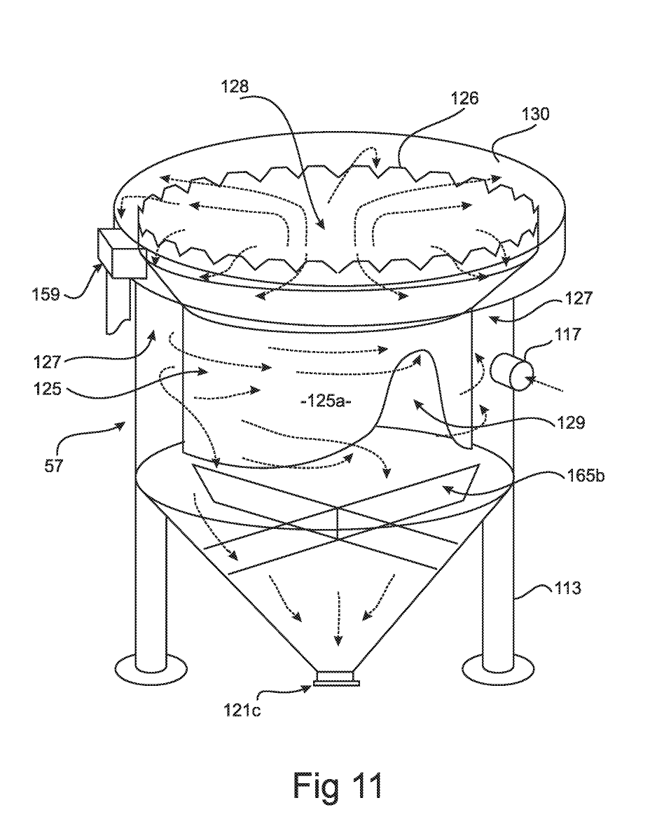

Now describing the method of operation of the treatment vessel 55, reference is made to FIG. 11 of the drawings in particular.

It will be appreciated that a start-up phase must be undertaken in order to fill the tank 57 with fluid and tune it chemically with the correct dosage of reagents to ensure optimum separation of particles from fluid introduced into the vessel. This is all considered to be part of knowledge within the art of particle separation using treatment plants of the general kind described, and will not be described further.

In the present embodiment of the best mode for carrying out of the invention, once the system and treatment vessel(s) are setup, fluid is introduced into the outer annular treatment region 127 tangentially so as to maintain the laminar flow of fluid therein. In this respect the shroud 118 enhances entrainment of the incoming fluid into the laminar flow of fluid within the tank and mitigates pluming of low specific gravity particles for a period of time until the laminar flow takes effect.

The tangential flow becomes transverse, following the contour of the tank, and progresses along the outer annular treatment region 127 until it gradually enters into the inner particle separation region 128 at different stages as a consequence of the particular formation of the parabolic recessed portion 129 and the reducing radius and increasing curvature of the leading depending cylindrical skirt portion 125a adjacent the recessed portion 129. As fluid moves closer to the central axis of the tank, it is less influenced by the vortex formed by the tangential entry of fluid into the tank and becomes more subject to the effects of the reagents and separating according to gravity. Consequently, particles and fluid with a higher specific gravity will tend to fall within the tank and fluid and particles (floaters) having a lower specific gravity will tend to rise within the tank.

As clarified fluid moves up within the inner particle separating region 128, the upper vortex breaker 165a ensures that all transverse movement is diminished allowing migration of fluid axially upwardly in the case of low specific gravity and downward in the case of high specific gravity. Clarified supernatant accumulates at the top of the tank and eventually migrates radially outward through the V notch weir 126a and into the gutter portion 130. Finally, clarified supernatant will be drawn off via the supernatant connector 121a at the launder 159.

The majority of the particles having a high specific gravity will move towards the lower regions of the tank 57. These particles will collect and form sludge in the lower conical portion 123b of the tank, where they are prevented from rat-holing by the action of the scraper unit 60. Periodically, the sludge is extracted from the bottom of the lower conical portion 123b by opening of the sludge connector 121c and operation of the sludge pump 69 associated with the particular treatment vessel.

In an alternative embodiment of the best mode for carrying out the invention, the fluid separating clarifier is substantially identical to the preceding embodiment, except that the depending cylindrical skirt portion of the baffle is of constant radius, and does not progressively decrease in radius in advance of the recessed portion.

Laminar flow should still be able to be achieved with this embodiment, without the added expense of manufacturing a baffle portion of varying radii.

In accordance with another mode for carrying out the invention, two embodiments will now be described.

The first embodiment is directed to a fluid separating clarifier 53′ of generally similar design to that described in the best mode for carrying out the invention, but having additional chambers at the top of the inner particle separating region in order to further clarify the resident fluid.

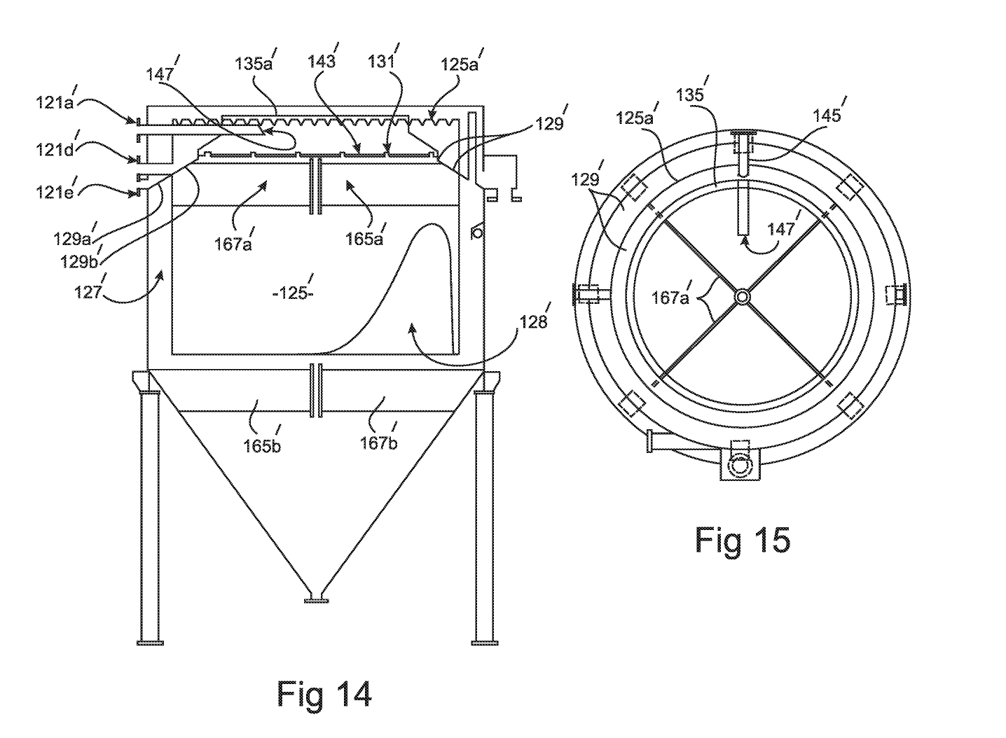

As shown in FIGS. 14 and 15, the top of the inner cylindrical baffle 125′ and the tank 57′ itself is of a different design. In the present embodiment, the interior of the tank is divided into discrete axial regions by an inner frusto-conical skirt portion 129′, which extends inwardly from the cylindrical wall portion 123a′ within the top half of the cylinder defined thereby, and through the baffle 125′, in an upward oblique direction to terminate with an upturned castellated lip 131′, as shown in FIG. 14. The frusto-conical skirt portion 129′ partitions the annular region between the inside of the cylindrical wall portion 123a′ and the outside of the baffle 125′ to separate the inner annular treatment region 127′ from the annular gutter 130′.

The castellated lip 131′ forms a seat surmounted by a frusto-conical shroud 133′ having an inner cylindrical flange portion 135′, co-extensive with the upper portion of the baffle 125′. The inner cylindrical flange portion 135′ extends through the opening of the baffle 125′ so that the upper edge 135a′ of the cylindrical flange portion 135′ terminates at a marginally higher location than the upper edge 125a′ of the ‘V’ notch weir portion.

In this manner: (i) the outer portion 129a′ of the frusto-conical skirt portion disposed on the outside of the baffle 125′ forms an oblique ceiling for the outer annular treatment region 127′ of the tank and a base for an annular gutter forming part of the supernatant discharge means; and (ii) the inner portion 129b′ of the frusto-conical skirt portion disposed on the inside of the baffle 125′ and the frusto-conical shroud 133′ combine to form an accumulation chamber 137′ at the top of the inner particle separating region 128′ and an annular settling chamber 139′ on the inside of the baffle 125′.

The base of the shroud 133′ is formed with a depending lip 141′, and is of marginally greater diameter than the top of inner frusto-conical skirt portion 129′. Consequently, the depending lip 141′ overlies the castellated lip 131′ and is relatively sized to form a gap between the distal end of the depending lip 141′ and the terminal end of the inner frusto-conical skirt portion 129′, thereby creating a flow inverter 143′. In this manner the castellations of the castellated lip 141′ form a series of passageways to allow fluid residing in the accumulation chamber 137′ to enter the flow inverter 143′, creating a tortuous path for fluid of low specific gravity to flow through and enter the annular settling chamber 139′.

It can also be seen that the floaters outlet connector 121a′ has a pipe 145′ extending radially inward of the tank, penetrating the wall of the baffle 125′ and the inner frusto-conical shroud, just below the level of the ‘V’ notch weir. The pipe 145′ terminates within the top portion of the accumulation chamber 137′ to provide an inlet 147′ for floaters disposed in the accumulation chamber to be extracted therefrom.

An inner particles connector 121d′ has a pipe 149′ extending radially inward of the tank, penetrating the wall of the baffle 125′ at the bottom of the annular settling chamber 139′ to provide an inlet 151′ for periodic extraction of high specific gravity particles that settle at the bottom of the settling chamber.

An outer particles connector 121e′ has a pipe 153′ extending radially inward and penetrating the cylindrical wall portion 123a′ of the tank 57′ at the bottom of the annular gutter 130′ to provide an inlet 155′ for periodic extraction of high specific gravity particles that settle at the bottom of the gutter.

In this embodiment, as clarified fluid moves up towards the accumulation chamber 137′, transverse movement of fluid is diminished by the vortex breaker 165a′ allowing migration of fluid radially outwardly at a particular specific gravity from within the accumulation chamber 137′ and through the flow inverter 143′ in the annular settling chamber 139′.

The majority of this fluid is supernatant and is permitted to clarify further within the settling chamber 139′ allowing high specific gravity particles to settle at the bottom thereof and be returned to the head of the works periodically via the inner particles connector 121d′.

As low specific gravity supernatant again rises, it will pass through the ‘V’ notch weir to cascade down the outer wall of the inner skirt portion and collect in the outer annular gutter 130′. Higher specific gravity particles will again settle at the bottom of the gutter 130′ and be returned to the head of the works periodically via the outer particles connector 121e′.

Finally, clarified supernatant will be drawn off via the supernatant connector 121a′ at the launder 159′.

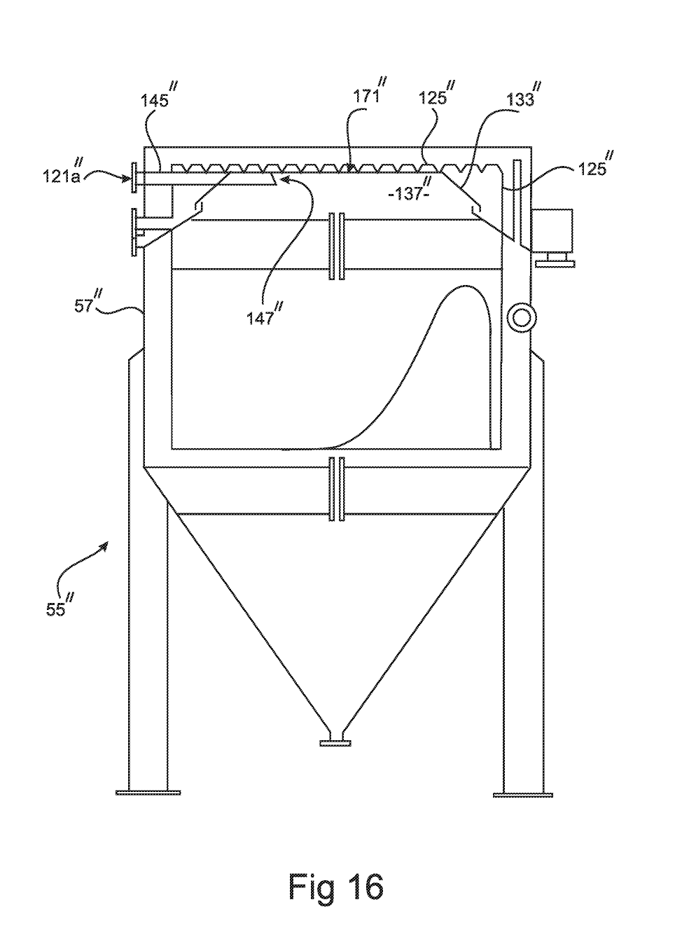

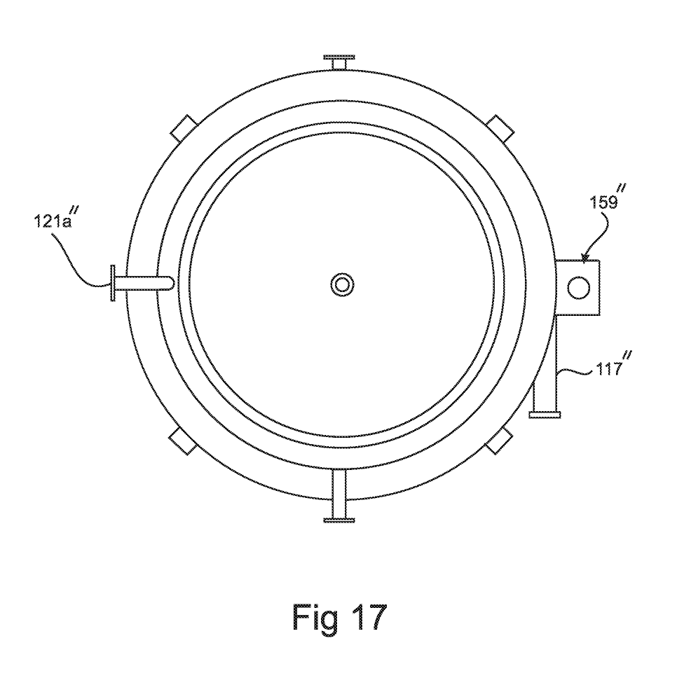

The second embodiment of the fluid separating clarifier 53″ according to the other mode for carrying out the invention is shown in FIGS. 16 to 18, is very similar to the first embodiment, and so the same reference numerals will be used to identify like components without describing the entire apparatus again, but will use a ″ symbol to indicate that the component relates to the second embodiment.

The essential difference between the fluid separating apparatus 53″ of the second embodiment is that the treatment vessel 55″ of the second embodiment includes a tank 57″ with the upper end of the inner frusto-conical shroud 133″ being closed to form a lid 171″ that closes the top of the accumulation chamber 137″ at a height marginally below the upper edge 125a″ of the inner skirt portion 125″. Thus, the inner frusto-conical shroud 133″ does not have an inner cylindrical flange portion 135′, but instead a top portion 171a″ that closes the shroud 133″.

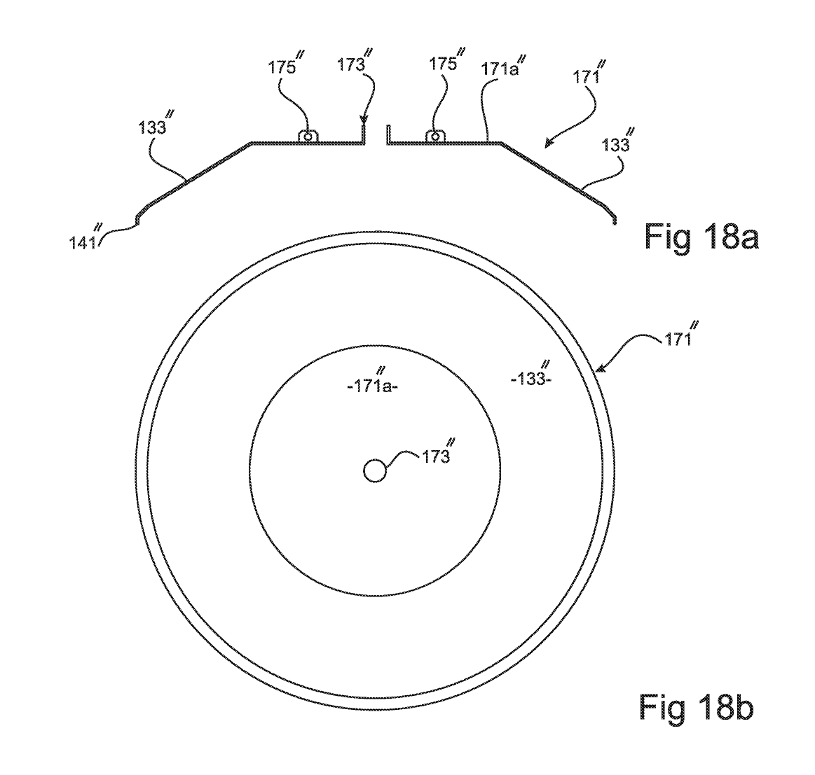

As shown in FIG. 18, the lid 171″ is provided with a central aperture 173″ that forms a bush for accommodating the shaft of the scraper and motor drive therefor (not shown). It also includes tabs 175″ to facilitate mounting of the motor drive thereto.

In this embodiment, the pipe 145″ of the floaters outlet connector 121a″, still extends radially inward of the tank and has an inlet 147″ that terminates within the top portion of the accumulation chamber 137″, immediately below the top portion 171a″ of the lid, to remove floaters therefrom.

The operation of the treatment vessel 55″ and the tank 57″ otherwise is the same as in the first embodiment.

An advantage of the first embodiment over the second embodiment is that the top portion adds additional weight to the tank. In instances where the size of such tanks is quite large, the weight savings in materials is particularly important.

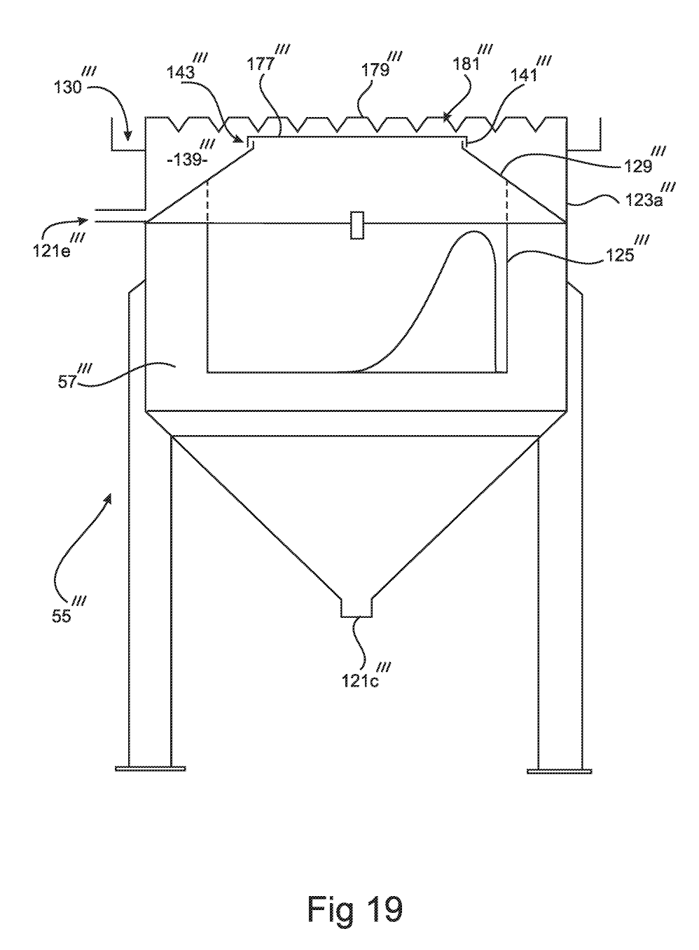

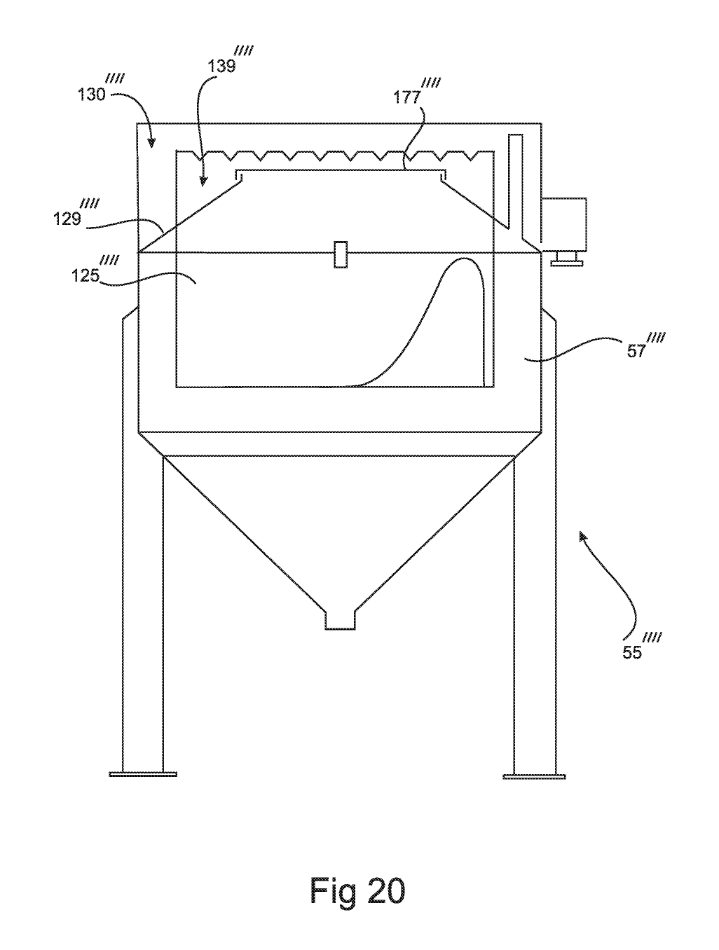

A further mode for carrying out the invention is shown in FIGS. 19 and 20. In the embodiment shown in FIG. 19, the treatment vessel 55′″has a different form of tank 57′″to that of the preceding embodiments, whereby the inner skirt portion 125″′ is formed integral with the inner frusto-conical baffle portion 129″′ and depends therefrom rather than extends therethrough.

Instead of the inner frusto-conical shroud 133′, a lid 177″′ is provided with a depending lip 141″′ that sits on the seat formed by the castellated lip 131″′ of the inner frusto-conical baffle portion 129″′ to form the flow inverter 143″′.

As the inner skirt portion 125″′ does not extend past the inner frusto-conical baffle portion 129″′, the annular settling chamber 139″′ is formed by the upper portion of the cylindrical wall portion 123a″′and the inner frusto-conical baffle portion 129″′. Furthermore, the upper edge 179″′ of the cylindrical wall portion 123a″′ is notched so as to form the ‘V’ notch weir portion 181″′, and the annular gutter portion 130″′ is peripherally mounted to the outside of the cylindrical wall portion 123a″′ to collect supernatant passing through the ‘V’ notch weir portion 181″′.

Outlet connectors 121″′ for floaters, supernatants, sludge 121c″′ and particles 121e″′ are provided at appropriate locations.

In the embodiment shown in FIG. 20, the treatment vessel 55″′reverts back to a tank 57″″of similar design to the tank described in the first mode for carrying out the invention, but adopts the arrangement of the lid 177″″ in lieu of the inner frusto-conical shroud 133′. In this arrangement, the inner skirt portion 125″″ extends through the inner frusto-conical baffle portion 129″″ to form the annular settling chamber 139″″ and the annular gutter 130″″ in the same manner as in the other mode.

It should be appreciated that various modifications to the embodiments present themselves to a person skilled in the art involving different combinations of innovative components described in the various modes and embodiments. Accordingly, it is envisaged that such different combinations of these components are deemed to fall within the spirit and scope of this invention as defined herein and do not detract from it. For example, in the second mode of the invention, instead of there being provided a flat lid, a concave lid may be provided to allow floaters to accumulate at the top of the accumulation chamber and facilitate extraction therefrom. Alternatively, a shroud may still be provided in lieu of the lid, but having a cylindrical flange portion contiguous with the depending lip, rather than a frusto-conical portion.

1. A particle separating apparatus for fluids containing particulate material, comprising:
a treatment vessel having an inlet for injecting fluid containing particulate material, and a plurality of outlets for separately discharging separated supernatant on the one hand, and separated particles on the other hand, from the fluid;
an outer annular treatment region for receiving fluid injected tangentially into said treatment vessel from said inlet and directing said fluid into a transverse, laminar flow within the vessel about a central axis thereof;
an inner particle separating region communicating with the outer treatment region to permit ingress of the injected fluid gradually from the transverse flow in a radially converging manner that maintains the laminar flow for fluid to eventually repose centrally of the treatment vessel for optimum residency in the inner particle separating region whilst mitigating the effects on fluid therein from the angular motion of fluid in the outer annular treatment region;
a lower particle collection region communicating with both the lower portion of the outer treatment region and said inner particle separating region for receiving separated particles from the fluid having a higher specific gravity; and
an upper supernatant separating region communicating with the top of the inner particle separating region for egressing supernatant from the fluid for extraction.

2. A particle separating apparatus as claimed in claim 1, wherein the particle separating apparatus includes a cylindrical baffle that positively separates the outer annular treatment region from the inner particle separating region and the upper supernatant separating region; the baffle having an axially extending recessed portion: (i) opening from the depending end of the baffle; (ii) defining an apex proximate to the axial position of the inlet; and (iii) spanning a transverse portion of the baffle immediately rearward of the inlet.

3. A particle separating apparatus as claimed in claim 2, wherein the recess spans a sector of the baffle of approximately 90°.

4. A particle separating apparatus as claimed in claim 2, wherein the recess is parabolic in shape.

5. A particle separating apparatus as claimed in any one of claim 2, wherein the transversely extending arc of the baffle from an axial extent proximately aligned with the point of inflection of the recessed portion at the depending end of the baffle that is distal relative to the rear of the inlet, is of progressively lessening radius until the apex, so as to maintain and direct the laminar flow of fluid from the outer annular treatment region into the inner particle separating region, axially along the baffle.

6. A particle separating apparatus as claimed in claim 1, including a supernatant discharge chamber for receiving egressed supernatant from the upper supernatant separating region and allowing discharge of the supernatant therefrom.

7. A particle separating apparatus as claimed in claim 1, wherein the outer annular treatment region is closed at the top thereof to collect buoyant particles.

8. A particle separating apparatus as claimed claim 1, wherein the upper supernatant separating region includes a weir to allow received supernatant to egress through for collection and retain buoyant particles having a lower specific gravity from the fluid for eventual extraction.

9. A particle separating apparatus as claimed in claim 1, wherein the upper supernatant separating region may include a settling chamber to receive supernatant from the top of the inner particle separating region prior to egressing the supernatant for extraction.

10. A particle separating apparatus as claimed in claim 9, wherein the upper supernatant separating region includes a flow inverter to create a tortuous path for flow of supernatant from the top of the inner particle separating region into the settling chamber.

11. A particle separating apparatus as claimed in claim 1, including a scraper to continuously scrape the inner wall of the lower particle collection region for agitating the collected particles and fluid at the bottom of the treatment vessel.

12. (canceled)

13. A treatment system for treating effluent from a processing plant, including: a reagent dosing station to dose the effluent with reagents in a controlled manner; a particle separating station comprising:
(i) a particle separating apparatus for fluids containing particulate material, comprising:
a treatment vessel having an inlet for injecting fluid containing particulate material, and a plurality of outlets for separately discharging separated supernatant on the one hand, and separated particles on the other hand, from the fluid;
an outer annular treatment region for receiving fluid injected tangentially into said treatment vessel from said inlet and directing said fluid into a transverse, laminar flow within the vessel about a central axis thereof:
an inner particle separating region communicating with the outer treatment region to permit ingress of the injected fluid gradually from the transverse flow in a radially converging manner that maintains the laminar flow for fluid to eventually repose centrally of the treatment vessel for optimum residency in the inner particle separating region whilst mitigating the effects on fluid therein from the angular motion of fluid in the outer annular treatment region;
a lower particle collection region communicating with both the lower portion of the outer treatment region and said inner particle separating region for receiving separated particles from the fluid having a higher specific gravity; and
an upper supernatant separating region communicating with the top of the inner particle separating region for egressing supernatant from the fluid for extraction;
(ii) a particles discharge station to return separated particles from the separating apparatus to the processing plant for treatment or extraction;
(iii) a sludge discharge station to return sludge extracted from the separating apparatus to the processing plant for treatment or extraction; and
(iv) a supernatant collection station to collect supernatant from the separating apparatus for subsequent use.

14. (canceled)

15. A method of separating particles from fluid comprising:
introducing fluid tangentially into a laminar flow at a fixed location;
gradually directing said fluid radially inwardly from a region behind the fixed location in a vortex maintaining the laminar flow until the fluid reaches the centre for optimum residency where transverse flow is reduced and axial flow subject to gravity is enhanced;
separating an outer annular treatment region of the fluid having angular fluid motion proximate to the fixed location from an inner particle separating region having fluid with a lesser angular fluid motion to shield fluid within the inner particle separating region from the effects of angular fluid motion in the outer annular treatment region;
accumulating fluid with low specific gravity towards the top and collecting particles and fluid with high specific gravity towards the bottom; and
egressing fluid radially outward from the top to extract supernatant therefrom.

16. A method of separating particles as claimed in claim 15, including slowly agitating the collected particles and fluid at the bottom to mitigate rising thereof.

17. A method of separating particles as claimed in claim 15, wherein egressing the extracted supernatant from the top includes separating buoyant particles having a lower specific gravity from the supernatant.

18. A method of separating particles as claimed in any one of claims 15, including passing the fluid through a flow inverter to settle before egressing the fluid to extract supernatant therefrom.

19. (canceled)
